(19) United States
(12) Patent Application Publication
(10) Pub. No.: US 2026/0220538 A1
(43) Pub. Date: Jul. 30, 2026

(54) EXCLUDING COMPROMISED LOCAL UNITS FROM RECEIVING GLOBAL PARAMETERS IN FEDERATED LEARNING SYSTEMS

(71) Applicants: Leon Reznik, West Henrietta, NY (US); Sergei Chuprov, West Henrietta, NY (US)

(72) Inventors: Leon Reznik, West Henrietta, NY (US); Sergei Chuprov, West Henrietta, NY (US)

(73) Assignee: Rochester Institute of Technology, Rochester, NY (US)

(21) Appl. No.: 19/149,171

(22) PCT Filed: Jan. 18, 2024
(86) PCT No.: PCT/US2024/012024

§ 371 Date: Jul. 18, 2025

Related U.S. Application Data
(60) Provisional application No. 63/439,995, filed on Jan. 19, 2023.

(51) Int. Cl. G06N 20/00

(52) U.S. Cl. CPC G06N 20/00

(57) ABSTRACT

A method for excluding one or more of a plurality of local units from a federated learning system is provided. The method includes (1) receiving a plurality of local parameters transmitted by each of the plurality of local units; (2) determining, based on the plurality of local parameters, one or more indicators for each of the plurality of local units; (3) designating one or more of the plurality of local units as compromised local units if the one or more of the plurality of local units are determined to be compromised based on the one or more indicators; (4) generating a plurality of global parameters by aggregating the plurality of local parameters; and (5) transmitting the global parameters to a trusted subset of the plurality of local units. The trusted subset excludes the compromised local units.

### CROSS-REFERENCE TO RELATED APPLICATIONS

This application claims the benefit of the filing date of U.S. Provisional Patent Application No. 63/439,995, filed Jan. 19, 2023, which is hereby incorporated by reference in its entirety.

### FIELD OF THE DISCLOSURE

The present disclosure relates to machine learning systems. More specifically, the present disclosure is directed to methods and systems for excluding compromised local units in a federated learning system from receiving global model parameters.

### BACKGROUND

Conventional federated learning operation flow does not envisage the possibility of excluding compromised local units from global update distribution. Accordingly, the global updates are distributed between all local units participating in the federated learning system or in an aggregation round of the system. This federated learning operation model may jeopardize the privacy of the data stored or produced by the local units participating in the aggregation. Various studies have addressed malicious local update detection and mitigation. However, the problem of further distribution of global updates back to the local units needs to be addressed in order to improve privacy and security of the federated learning process.

FIG. 1 is a schematic view of a prior art federated learning system 10. Broadly, the federated learning system 10 includes an aggregation unit 100 and three local units 200a, 200b, 200c. The local units 200a, 200b, 200c are configured to transmit the local parameters 202a, 202b, 202c to the aggregation unit 100. The aggregation unit 100 aggregates the local parameters 202a, 202b, 202c to update a global machine learning model defined by a plurality of global parameters 104. The aggregation unit 100 then transmits the global parameters 104 back to each of the local units 200a, 200b, 200c. Upon receiving the global parameters 104, a local unit 200 may then update their corresponding local machine learning model based on the global parameters 104. However, if one of the local units 200a, 200b, 200c has been compromised by a malicious adversary, distributing these global parameters 104 may threaten the privacy of the data processed by the federated learning system 10.

### SUMMARY OF THE DISCLOSURE

The present disclosure is generally related to methods and systems for excluding compromised units in a federated learning system from receiving global model updates. The systems include a plurality of local units and an aggregation unit. The local units may be discrete computing devices, such as smartphones, while the aggregation unit may be a centralized cloud-based system. Each of the local units include local machine learning models with local parameters updated according to received local data. The local units transmit the local parameters to an aggregation unit. The aggregation unit includes a global machine learning model and processes the local parameters to determine one or more indicators for each of the local units. The indicators identify the likelihood that the corresponding local unit has been compromised and is providing malicious data. The indicators may include truth indicators, reputation indicators, and/or trust indicators. Based on these indicators, one or more of the local units are designated as compromised local units. The aggregating unit also generates a plurality of global parameters by aggregating the local parameters. The aggregating unit then transmits the global parameters to a trusted subset of local units which excludes the compromised local units. This prevents a potential adversary from gaining access to the global machine learning model and conducting inference attacks. In further examples, the local parameters provided by compromised local units are excluded from the aggregation process. In even further examples, the aggregation unit may entirely block communication with any compromised local units.

Generally, in one aspect, a method for excluding one or more of a plurality of local units from a federated learning system is provided. The method includes receiving a plurality of local parameters transmitted by each of the plurality of local units.

The method further includes determining, based on the plurality of local parameters, one or more indicators for each of the plurality of local units.

The method further includes designating one or more of the plurality of local units as compromised local units if the one or more of the plurality of local units are determined to be compromised based on the one or more indicators.

The method further includes generating a plurality of global parameters by aggregating the plurality of local parameters.

The method further includes transmitting the global parameters to a trusted subset of the plurality of local units, wherein the trusted subset excludes the compromised local units.

According to an example, the aggregating of the plurality of local parameters excludes a portion of the local parameters corresponding to the compromised local units.

According to an example, the method may further include blocking communication between an aggregation unit and the compromised local units. The aggregation unit may be a cloud-based system.

According to an example, the method may further include transmitting verification parameters to the compromised local units.

According to an example, the compromised local units may be designated by comparing the one or more indicators of each of the plurality of local units to one or more thresholds.

According to an example, the one or more indicators includes one or more of a truth indicator, a reputation indicator, and a trust indicator. The truth indicator corresponding to one of the plurality of local units is determined based on a data quality evaluation of the plurality of local parameters associated with the one of the plurality of local units. The reputation indicator corresponding to the one of the plurality of local units is determined based on the truth indicator corresponding to the one of the plurality of local units and a plurality of historical truth indicators. The trust indicator corresponding to the one of the one or more of the plurality of local units is determined based on the truth indicator and a previous time moment reputation indicator.

According to an example, the plurality of local units include local machine learning models. The trusted subset of the plurality of local units update the local machine learning models based on the global parameters. The plurality of local parameters may be generated by the local machine learning models of the each of the plurality of local units by processing local data. The plurality of local units may capture the local data via one or more input sensors.

Generally, in another aspect, a non-transitory computer readable storage medium is provided. The computer readable storage medium has computer readable code embodied. The computer readable code is configured such that, on execution by a suitable computer or processor is caused to perform a method. The method includes (1) receiving a plurality of local parameters transmitted by each of a plurality of local units; (2) determining, based on the plurality of local parameters, one or more indicators for each of the plurality of local units; (3) designating one or more of the plurality of local units as compromised local units if the one or more of the plurality of local units are determined to be compromised based on the one or more indicators; (4) generating a plurality of global parameters by aggregating the plurality of local parameters; and (5) transmitting the global parameters to a trusted subset of the plurality of local units, wherein the trusted subset excludes the compromised local units.

Generally, in yet another aspect, a federated learning system is provided. The federated learning system includes an aggregation unit. The aggregation unit is configured to (1) receive a plurality of local parameters transmitted by each of a plurality of local units; (2) determine, based on the plurality of local parameters, one or more indicators for each of the plurality of local units; (3) designate one or more of the plurality of local units as compromised local units if the one or more of the plurality of local units are determined to be compromised based on the one or more indicators; (4) generate a plurality of global parameters by aggregating the plurality of local parameters; and (5) transmit the global parameters to a trusted subset of the plurality of local units, wherein the trusted subset excludes the compromised local units.

According to an example, the aggregation unit is a cloud-based system.

According to an example, two or more of the plurality of local units are physically distributed.

According to an example, two or more of the plurality of local units are logically distributed within a single device.

According to an example, the plurality of local parameters are generated by local machine learning models of the each of the plurality of local units by processing local data. Each of the plurality of local units comprise one or more input sensors configured to capture the local data.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software, firmware, or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a prior art federated learning system, in accordance with an example.

FIG. 2 is a schematic view of a federated learning system configured to exclude compromised local units, in accordance with an example.

FIG. 3 is a high-level functional block diagram of a federated learning system, in accordance with an example.

FIG. 4 is a functional block diagram of a local unit of a federated learning system, in accordance with an example.

FIG. 5 is a functional block diagram of a communication channel of a federated learning system, in accordance with an example.

FIG. 6 is a functional block diagram of an aggregation unit of a federated learning system, in accordance with an example.

FIG. 7 is a detailed functional block diagram of a federated learning system, in accordance with an example.

FIG. 8 is a schematic diagram of an aggregation unit, in accordance with an example.

FIG. 9 is a schematic diagram of a local unit, in accordance with an example.

FIG. 10 is a flow chart of a method for excluding one or more of a plurality of local units from a federated learning system, in accordance with an example.

### DETAILED DESCRIPTION OF EMBODIMENTS

The evolution of communications, data science, and machine learning (ML) fields, as well as growing privacy protection requirements, have resulted in the emergence of a federated learning (FL) paradigm. Federated learning allows for privacy and security enhancement by storing training data locally and improving data communication efficiency by not transferring significant amounts of data from a local unit to an aggregation unit. This technique was first introduced to improve smartphone keyboard query suggestions. In general, the federated learning process consists of several stages. First, local machine learning models of each local device are trained locally on data available therein. Second, parameters of the local machine learning models are transmitted to the aggregation unit. Third, the received parameters of the local models are aggregated by the aggregation unit. Fourth, model updates produced by the aggregation unit are communicated back to the local units for the next training round. The federated learning process may, in some cases, require multiple iterations to produce a model which satisfies user and application requirements. The federated learning goal of privacy protection is accomplished mainly by communicating only the parameters of the local models instead of the original data to the aggregation units. Other techniques of further security and privacy enhancement have been proposed and incorporated into federated learning applications, such as: (1) employing more robust aggregation functions, e.g., geometric median instead of averaging; (2) federated learning based on dynamic regularization; and (3) personalized federated learning by pruning.

The conventional federated process includes the action of sending back the global model updates from the aggregation unit to local units in each aggregation round without considering the possibility that these local units might be compromised by an adversary that may result in a major privacy violation. In this case, the adversary might gain unauthorized access to these global updates and apply data inference attacks to derive sensitive information. The leak of this information may violate the privacy of local units participating in the federated learning system. These attacks might be employed to infer the data stored on the local unit, which poses clear privacy concerns. Various studies have addressed malicious update detection and mitigation. Unlike other approaches, the present disclosure leverages novel knowledge-based methods, which allow for (1) detecting and (2) excluding compromised local units from the global model distribution. Based on the extracted knowledge of local updates, the local units are categorized as trusted or compromised. If a local unit is classified as compromised, it is not provided the actual global model update. Further actions on managing compromised local units may depend on the user and application requirements. For example, they can be completely discarded from the aggregation and blocked from accessing the federated learning system, or they can be supplied with specially constructed fake global updates with an integrated backdoor that allows tracking the activity of these units and infer the adversary capabilities and strategy.

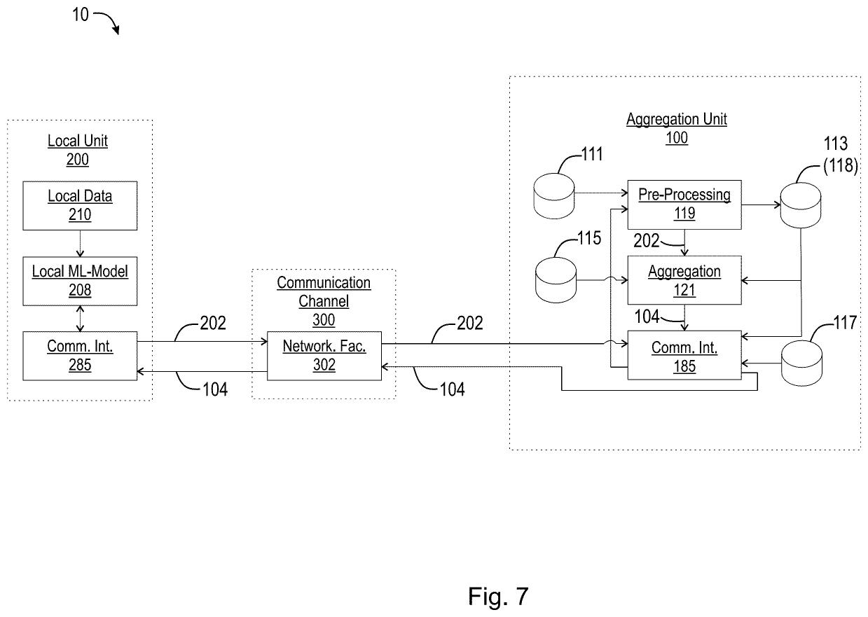

Detecting compromised local units based on their local updates might be performed with various statistical and intelligent techniques. In this disclosure, a federated learning system's model and methods for security and privacy enhancement are described. The federated learning system's model includes the system's components and their interrelations (as shown, for example, in FIG. 7). The employed methods can be categorized as follows.

The disclosed system includes methods for pre-processing parameters of local models via the aggregation unit. These methods allow comparing and clustering the parameters of all the received local update parameters. Here, various statistical and/or intelligent techniques might be employed.

The disclosed system further includes knowledge-based methods, which enable excluding compromised local units from the global model distribution. As an example, reputation and trust-based mechanisms may be employed. These mechanisms involve identifying trusted and potentially compromised local units based on the model updates they send for the aggregation. The reputation and trust toward each local unit is evaluated based on the model update parameters submitted by each unit and accumulated over the whole federated learning training process. The reputation and trust indicators facilitate the aggregation procedure, and allow for tracking local unit's training activity.

Delivery of local and global updates represents a security concern for federated learning, also, as it has to maintain secure, cheap, efficient, and reliable communication of the model updates. To address the communication challenges, secure communication mechanisms and protocols might be employed by the federated learning system user and/or owner, such as secure multiparty computation (SMC) and Differential Privacy. SMC leverages secure cryptographic protocols that conceal local models' updates from the aggregation unit. This approach enables assured local privacy but with extra communication and computation costs. Differential privacy mechanisms involve various techniques to prevent the inference of sensitive information from the available data. These techniques may include sensitive data substitution, modification, encryption, etc.

While the disclosed systems and methods do not directly address or modify the model updates communication process, its application might reduce the amount of data to be transferred and the number of units to communicate with.

The disclosed systems and methods may be further described as follows. The model of the federated learning system enables enhancing data privacy and security by excluding local units identified as compromised from receiving global model updates.

The privacy of user's local data can be violated by various ways: e.g., by the malicious access to the local or aggregation unit or by the interception of local or global model updates during their transmission over the communication channel. The disclosed systems and methods address and mitigate the inherent federated learning conventional method privacy vulnerability that involves distributing the global model parameters to all local units, participating in the aggregation round. In the case when the local unit has been already compromised, in the process or after the local training, in the conventional federated learning scheme the adversary would be provided with the aggregated model that could be maliciously utilized for preparation and execution of further data inference attacks. Examples of data inference attacks that may be applied in the federated learning environment include class representatives inferring, membership inference, training data properties inference, and training samples and labels inference. As the aggregated model is commonly produced based on multiple models locally trained on local units, data inference techniques may allow an adversary to extract sensitive information about these local units' data. For example, the adversary might infer the information if specific data samples are contained in the training data.

The disclosure assumes that some local units might be identified as compromised as a result of previous attacks. The disclosed systems and methods are posed as a defense mechanism in a case of, for example, attack scenarios. Either single or multiple adversaries that are able to compromise one or multiple local units are considered. The adversaries might gain access to local units by using any available means, e.g.: unauthorized physical access to the local unit; unauthorized remote access to the local unit; by leveraging a backdoor, etc. Active adversaries may maliciously manipulate the data or the model of the local unit. These manipulations might influence the local model parameters, and these manipulations may be detected by the proposed pre-processing methods implemented on the aggregation unit. Using specially developed and implemented methods, local units that sent suspicious model parameters for aggregation will be discarded from further aggregation rounds and will not receive the global model parameters. By preventing maliciously attacked local units from receiving global model updates, the adversary is hindered from gaining access to the global model and conducting inference attacks, which allows the system to avoid privacy violations. As the conventional federated learning scheme does not possess any techniques to exclude local units from the global model distribution, the disclosed systems and methods are intended to enhance the data privacy and security and improve the overall robustness of the federated learning process.

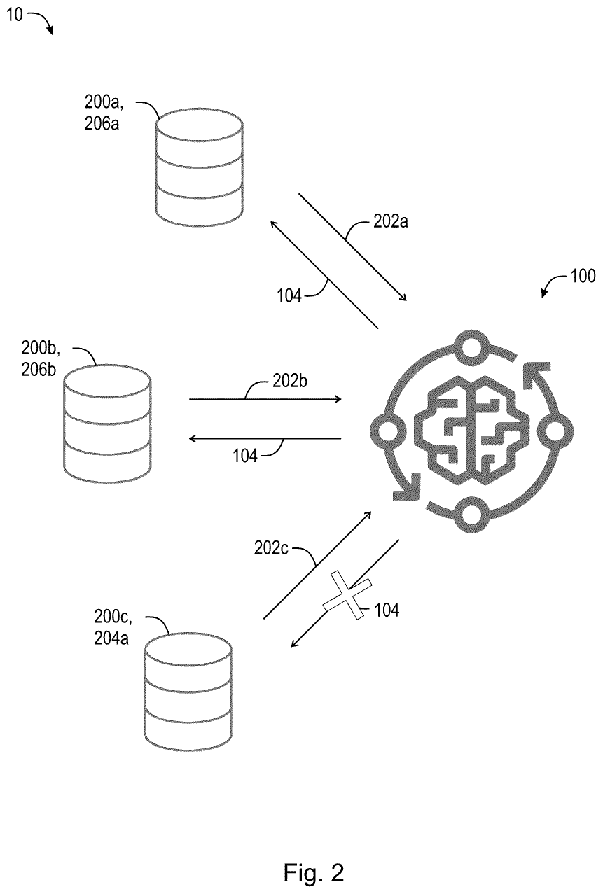

The adversary's ability to gain unauthorized access to the global model is considered as a possible severe privacy violation. Accordingly, a novel approach is described to exclude malicious local units from receiving the global model parameters (see, for example, FIG. 2). As an example of the disclosed systems and methods, the incorporation of the local updates pre-processing component is relied on, which may employ existing methods to categorize local units into trusted and compromised ones. Local updates pre-processing methods may incorporate various statistical and intelligent inspection procedures, which allow detecting local models, submitted by compromised units. If the local unit is classified as compromised, it does not receive the global model update. Further actions on managing compromised local units may vary: the local unit may be excluded from receiving the aggregated model; the local unit may be completely blocked from communication with the aggregation unit; and/or the local unit may be supplied with a specially constructed aggregated model (not the original global model) to verify if the local units were compromised; etc.

The disclosure assumes that the local units participating in the aggregation need to be associated with the model update parameters they submit to the aggregation unit. This association is required to determine which local units will be discarded from global model distribution. The leak of the particular local unit categorization results (trusted or compromised) may pose another privacy threat, as this data may be used by the adversary with their malicious intent. However, this threat is out of the scope of this disclosure.

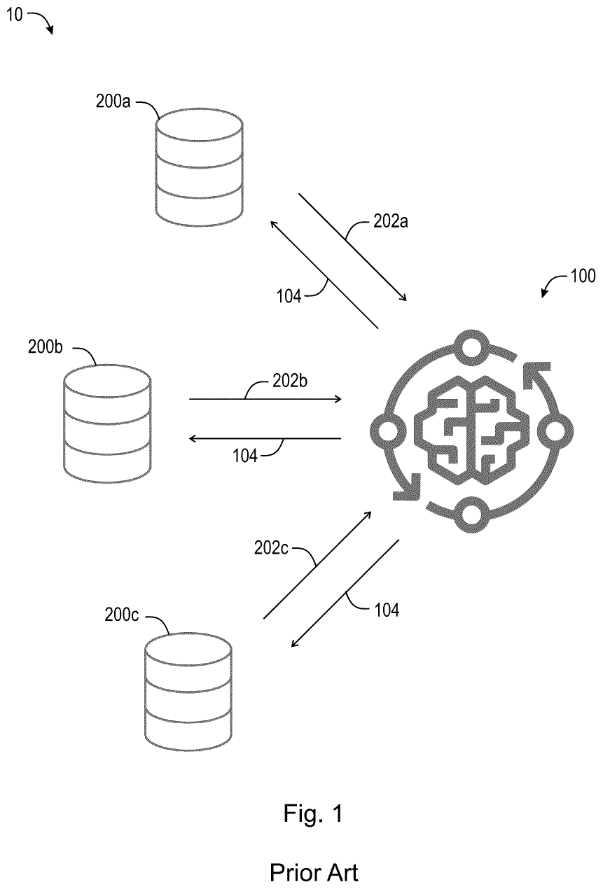

As the disclosure is described on a system level, the particular preaggregation inspection procedures and global model distribution decision making methods may vary and depend on the federated learning system user and application requirements. Below we describe the architecture of the considered federated learning system and the component structure and functionality. The federated learning system architecture consists of three major components: a local unit, a communication channel, and an aggregation unit (see FIGS. 1 and 7).

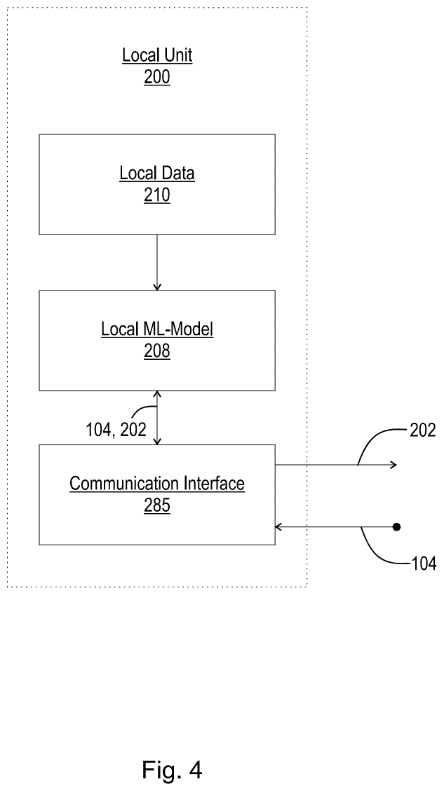

The federated learning system architecture usually includes a set of local units logically (and sometimes, physically) distributed over the federated learning environment. A single local unit may be represented as a separate device or as a combination of software and hardware implemented on a computing device. For example, it can be a user's smartphone or a software program on a remote server, which is responsible for local data storage and local model training. A local unit may collect the data by itself using sensor devices or may only store the data in its memory. A single local unit includes three major components: local data, a local Machine Learning (ML)-based model, and a communication component (see FIG. 4).

The local data component may include both software and hardware facilities for local data collection and storage. An example may be a combination of sensor devices, which collect the data, software, hardware or a combination thereof, which digitizes and processes this data, and the computing device memory, which is used to store this data.

The local ML-based model may include methods and facilities that implement an ML-based model. The ML-based model may be realized as any model depending on the user and application requirements, data type, and other important characteristics. For example, it can be based on random forest or logistic regression algorithms. This component is responsible for local ML-based model training and parameter updating based on the received global model parameters. This component may also include methods and tools for ML-based model performance evaluation. For instance, the local ML-based model may evaluate ML-based model performance using training accuracy or training error.

The communication interface is responsible for the communication between the local and the aggregation units. In particular, the communication interface facilitates transmitting local parameter updates and receiving global parameter updates. This component may be integrated into the local unit, or it may be realized as a separate component, which provides access to the network communication facilities.

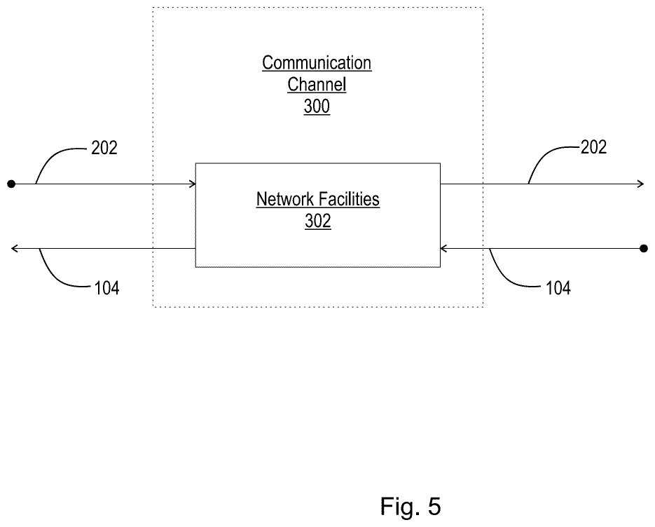

In federated learning system architecture, all the local units are capable of communicating with the aggregation unit. A communication channel between the local units and the aggregation units forms a part of a transmission system comprised of network stations and the transmission lines connecting them (see FIG. 5). The communication channel may be partially or fully based on the third party's Internet Service Provider (ISP) facilities or might be originally established and fully controlled by the federated learning system user. To transfer local and global updates, the communication channel may employ any data transfer technology and protocols depending on the network characteristics and based upon the user and application requirements. For example, it may employ a IEEE 802.11x technology standard for the wireless data transmission.

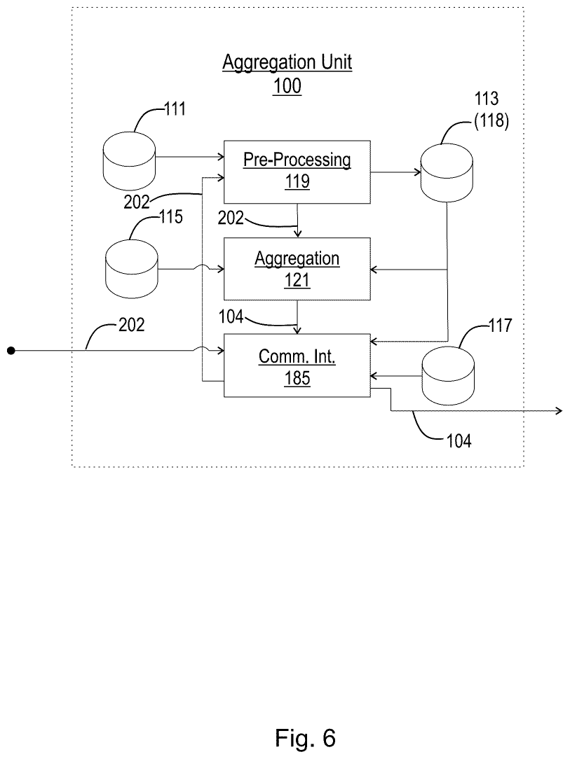

Depending on a particular federated learning system realization, an aggregation unit may be centralized or decentralized. In the former case, there is a central aggregation unit which is responsible for the aggregation procedure. In the latter case, the aggregation unit responsibilities are shared between all the local units. The aggregation unit may be implemented as software, for example as a cloud application, or a combination of software and hardware. The aggregation unit is responsible for collecting model parameter updates from the local units, aggregating them into a global model using an aggregation function, and distributing global model parameter updates back to the local units. The aggregation unit includes the following main components (see FIG. 6).

A local models pre-processing component serves as an example of how local updates analysis might be employed to detect compromised local units. This component may employ various methods and tools to distinguish between the trusted and compromised local units. For example, it may employ statistical methods to analyze the distribution of the received local updates and divide them into clusters. These clusters may be further used to categorize local units and decide which of them will be discarded from the global update parameter distribution. The collected local model update parameters are first pre-processed by this component. The output of this component is a list of local units categorized into trusted and compromised categories.

The aggregation component is responsible for aggregating the received local model parameter updates into a global machine learning model. The aggregation component may employ any aggregation function based on the user and application requirements, for example federated averaging. The aggregation component may select local update parameters for the aggregation based on the categories, provided by the local models pre-processing component. For example, it may discard all the update parameters sent by compromised local units (according to the list determined by the pre-processing component) from the aggregation procedure. The output of the aggregation component is a set of global model update parameters, which is then distributed back to the local units.

A communication interface is responsible for maintaining the communication between the aggregation unit and the local units. Depending on the implementation, the communication interface can be realized as software, or as a combination of software and hardware. The communication interface receives local updates and associates them with the local units sent these updates. After the global model parameters are produced by the aggregation unit, the parameters are forwarded to the local units participating in the aggregation round.

The federated learning flow may incorporate multiple aggregation rounds, which are repeated until the produced global machine learning model meets termination criteria. Such criteria might be, for example, the performance required by the user and application requirements. There are various operational processes incorporated in the federated learning system's single aggregation round with several stages, which we describe below.

The first stage is a local training stage. At this stage, an ML-based model is trained on a local unit over the data stored or collected therein. The model is trained on each local unit that participates in the aggregation round. Training might continue until the local unit's termination criteria is met, which can be established by the user and application requirements. For example, the termination criteria can include a number of training epochs, training performance, or a specified time limit. After the training, the local model is produced. The parameters of this local model are forwarded to the local unit's communication interface to be conveyed to the aggregation unit over the communication channel. The particular set of ML-based model parameters may vary and depends on the employed data type, implementation, and on the user and application requirements. For example, the transferred set of local parameters may include an ML-based model's gradients, weights, current model's condition, etc. The particular way of how the transferred ML-based model's parameters are encoded, packed, or represented for the transfer depends on the particular federated learning system application.

The second stage is a communicating local model updates stage. At this stage, the produced model's parameter updates by the local units participating in the aggregation round are transferred to the aggregation unit over the communication channel. This stage includes processes of sending the local model update parameters by the local unit, of transferring the local model update parameters over the communication channel's network facilities, and receiving the local model's updates by the aggregation unit.

The third stage is a local models' pre-processing stage. In this example of the disclosed systems and methods, at this stage the received local updates may be pre-processed to determine compromised local units. This stage might be composed of the following processes: (1) pre-processing the local ML-based model's parameters with the employed methods and tools to build the distribution of the parameters' values; and (2) pre-processing ML-based model's parameters clustering in order to detect compromised local units. The particular methods for local updates pre-processing may vary. For example, statistical or intelligent-based methods might be employed for local updates clustering. After the pre-processed ML-based models' clustering, a list of compromised local units participating in the aggregation round is produced.

The fourth stage is an aggregation stage. At this stage, the received local update parameters are aggregated by the aggregation unit with a specified aggregation function. The received local update parameters may be excluded from the aggregation according to the rules specified by the user. For example, they might be excluded based on the previous categorization on trusted and compromised local units. After the aggregation, the global model is produced. The parameters of the produced global model are then forwarded to the aggregation unit's communication interface to be sent back to the local units participating in the aggregation round. Local units that will not receive global update are determined based on the previous categorization into trusted and compromised local units. Compromised local units are discarded from receiving the global updates.

The fifth stage is a communicating global model updates stage. At this stage, the parameters of the produced global updates are communicated from the aggregation unit back to the local units participating in the aggregation round over communication channel. The parameters of the global updates are sent only to those local units not excluded from global model distribution. This stage includes the process of sending the parameters of the global model updates by aggregation unit to the selected local units, the process of transferring the parameters of the global model updates over the communication channel's network facilities, and the process of receiving the parameters of the global model's updates by the local units not excluded from the global model distribution.

Aspects of the systems and methods of this disclosure can be realized as a software tool, or as a combination of hardware and software tools integrated into the federated learning system with the aggregation unit responsible for aggregating the parameters of the local updates. The relationship between the local units and the local parameters they transfer should be established to allow identifying compromised local units and excluding them from the global model distribution.

The disclosed systems and methods can be applied to the federated learning system with a centralized or decentralized aggregation unit. The federated learning system should allow the identification of local units participating in the aggregation round in order to exclude compromised units from the global model distribution. The federated learning system may implement any ML-based model and data type depending on the user and application requirements. Malicious manipulations performed by an adversary on the training data and/or ML-based model are assumed to influence the local model updates being transmitted to the aggregation unit. The potential uses of the systems and methods of this disclosure might include a wide variety of problems, in which multiple ML-based models and the local units they are trained on can be organized in the federated learning system. The implemented federated learning system should satisfy the conditions and assumptions mentioned above. Some examples of the ML problems that might be solved with the implementation of the federated learning system are, for example, (1) classification of Society for Worldwide Interbank Financial Telecommunications (SWIFT) transactions data distributed over various banks; (2) prediction of individual risk of COVID-19 infection based on data on social contacts wherein the data is distributed over various regional health institutions; (3) smart keyboard relevant word predictions based on the training data distributed over the users' smartphones; (4) ML-based models for diagnosis and treatment predictions based on the training data on electronic health records, distributed over various medical institutions; (5) image classification with Deep Neural Network (DNN) models for Vehicular Edge Computing (VEC) based on the image training samples distributed over various VEC nodes. The systems and methods of this disclosure might be employed in any federated learning system application in order to enhance privacy and security of the federated learning system.

The disclosed systems and methods allows for enhancing privacy and security of the local training data in comparison to conventional federated learning models. This enhancement is achieved by preventing compromised local units from receiving the global updates, which decreases the risk of an adversary gaining an unauthorized access to the global model. Moreover, the invention might employ knowledge-based mechanisms that allow tracking the quality of the parameters of the local updates sent to the aggregation unit over the whole learning process and using this knowledge to decide which local units should be discarded from the distribution of the global updates.

The disclosed systems and methods may be considered as both knowledge-based and generic. The systems and methods may be considered to be knowledge-based, as the systems and methods generate and utilize internal knowledge on models and units to facilitate the aggregation and global updates distribution. Further, the systems and methods may be considered to be generic, as the systems and methods may be employed with any ML-based model and data type, which means that the invention can be employed in various application domains and implementation platforms. The disclosed systems and methods are not tied to a specific data type, ML-based model, domain, or application.

In summary, the disclosed systems and methods generate and utilize knowledge on local updates and units which send these updates to the aggregation unit, which allows enhancing privacy and security of the federated learning system. While the disclosure does not contribute to maintaining a secure and reliable communication channel between the local and aggregation units, it can be integrated with state-of-the-art secure communication protocols. Moreover, the disclosed system is generic and does not focus on a particular application domain.

Approaches to federated learning security and privacy assurance is a recently emerging state-of-the-art topic that integrates diverse technologies and methods ranging from communication and encryption to ML. For example, in communication and encryption domains, there are only a few well-known mature solutions in the literature that were adapted to federated learning, e.g., SMC, differential privacy, and homomorphic encryption, the effects of which on federated learning security and performance are still being investigated by the research community.

Identification of compromised local units is a sophisticated operation, which is based on detection of anomalies in local updates. This operation requires the application of advanced methods and techniques, which require additional expertise and are application specific. The disclosed systems and methods not only employ sophisticated compromised local units detection methods, but also utilize knowledge extracted by these methods in the further federated learning stage to decide which units should be excluded from the global model distribution. The disclosed systems and methods enables avoiding the scenario when a compromised local unit gains unauthorized access to the global model and implements data inference attacks, which might jeopardize the security and privacy of other local units. As a result, the invention allows for enhancing privacy and security of the whole federated learning system.

In the conventional federated learning process, the parameters of global updates are distributed to all the local units participating in the federated learning system or in the aggregation round. In contrast, the disclosed systems and methods introduce a novel approach of discarding compromised local units from the global updates distribution. The disclosed systems and methods require an advanced multidisciplinary knowledge in computer security and privacy, artificial intelligence and machine learning, mathematics, and simulation as well as other techniques.

The disclosed systems and methods may be used to solve the following problems. First, the disclosed systems and methods may enhance the privacy and security of the data residing on local units by detecting and discarding compromised units from the global updates distribution. Second, the disclose systems and methods may enhance robustness of the federated learning process by pre-processing local model updates and detecting parameters that lie out of the major local model's parameters cluster. These outliers might be a result of an adversary's malicious manipulations on local data and/or model. Based on the clusterization results, such local updates might be further discouraged or discarded from the aggregation to improve the global model performance and robustness.

The disclosure will be further illustrated with reference to the following specific examples. It is understood that these examples are given by way of illustration and are not meant to limit the disclosure or the claims to follow.

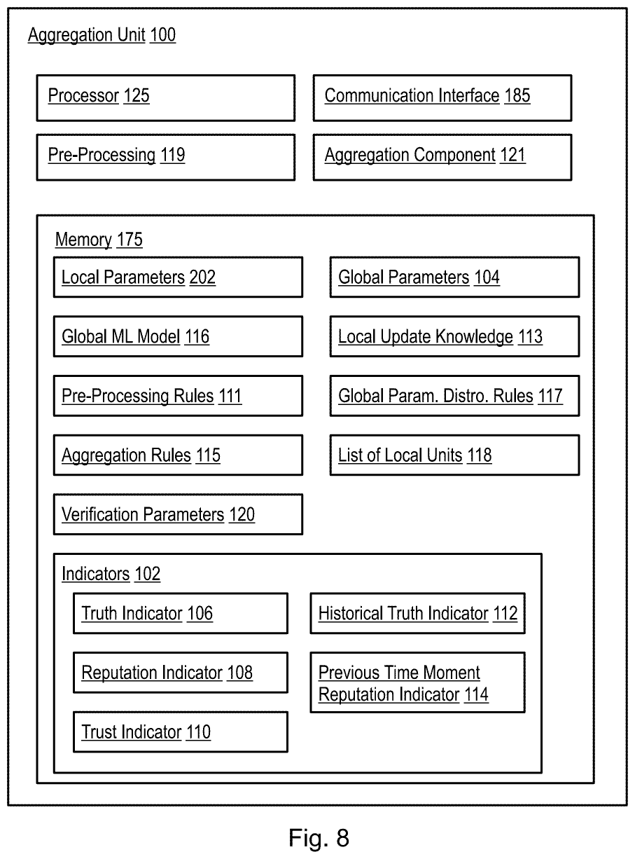

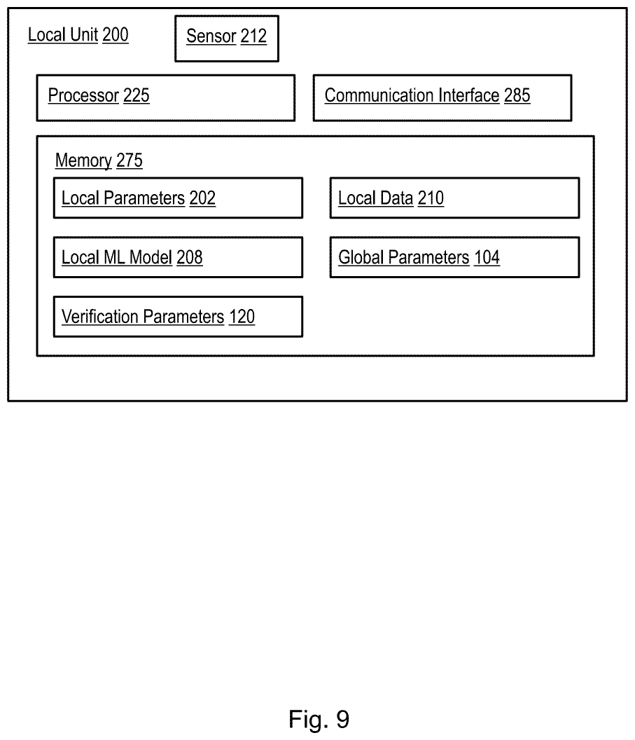

The following description should be read in view of FIGS. 2-10. FIG. 2 illustrates a schematic view of the federated learning system 10 implementing systems and methods for excluding compromised local units 204. The federated learning system 10 includes an aggregation unit 100 and three local units 200a, 200b, 200c. The aggregation unit 100 is shown in more detail in FIGS. 6 and 8. An example local unit 200 is shown in more detail in FIGS. 4 and 9. In other examples, any practical number of local units 200a, 200b, 200c may be included. The local units 200a, 200b, 200c may be physically or logically distributed. For example, the local units 200a, 200b, 200c may be physically distributed in an embodiment where a first local unit 200a is a smartphone, a second local unit 200b is a laptop computer, and a third local unit 200c is a desktop computer. In other examples, the local units 200a, 200b, 200c may all be integrated into a single device but logically separated such that each of the local units 200a, 200b, 200c trains a corresponding local machine learning model independently from the other local units 200a, 200b, 200c. In some examples, the aggregation unit 100 is a cloud-based system comprising one or more memory and processing components.

As shown in FIG. 9, each of the local units 200a, 200b, 200c includes a processor 225, a memory 275, and a communication unit 285. Further, each of the local units 200a, 200b, 200c includes a local ML model 208 defined by a plurality of local parameters 202. The local data 210 may be collected by sensors 212 of the local unit 210 or received via any other practical means. The local data 210 may be stored in the memory 275 of the local unit 200. The local data 210 is used to train the local ML-model 208, resulting in an update to the plurality of local parameters 202.

In the example of FIG. 2, the first and second local units 200a, 200b have been identified as first and second trusted units 206a, 206b by the aggregation unit 100 through an analysis of their associated local parameters 202a, 202b. Similarly, the aggregation unit 100 has identified the third local units 200c as a first compromised unit 204a through an analysis of the associated local parameters 202c. The identification of local units 200 as trusted or compromised is described with more detail in reference to FIG. 6. Accordingly, while the first and second local units 200a, 200b continue to receive the global parameters 104 as shown in FIG. 1, the aggregation unit 100 no longer transmits the global parameters 104 to the third local unit 200c, enhancing privacy by preventing, for example, inference attacks. In other examples, additional actions against a compromised unit 204 may be implemented, such as completely blocking communication with the aggregation unit 100 or transmitting verification parameters 120 of a specially constructed aggregated verification model to verify the local unit 200 was compromised.

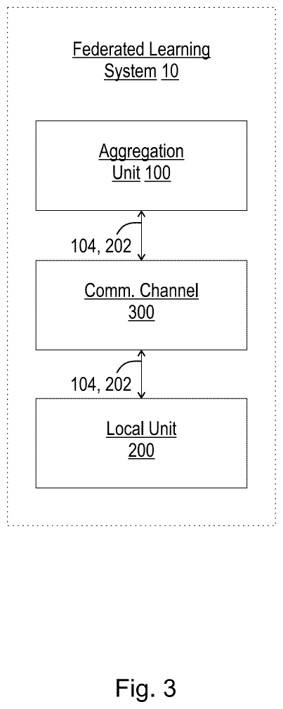

FIG. 3 illustrates a high-level block diagram of the federated learning system 10. As shown in FIG. 3, the federated learning system 10 includes the aggregated unit 100, the local units 200, and a communication channel 300. The communication channel 300 is configured to enable (1) local parameters 104 to be transmitted from the local units 200 to the aggregation unit 100 and (2) global parameters 202 to be transmitted from the aggregation unit 100 to the local units 200.

FIG. 4 illustrates a block diagram of a non-limiting example of a local unit 200. The local unit 200 includes the local data 210, the local ML-model 208, and a communication interface 285. The local data 210 is provided to the local ML-model 208 for training purposes. Through the training process, the local-ML model 208 generates updated local parameters 202 defining the local-ML model 208. The local parameters 202 are then provided to the communication interface 285 which facilitates transmission of the local parameters 202 to the aggregation unit 100. The communication interface 285 may enable any combination or wireless and or wired communication between the local unit 200 and the aggregation unit 100. Similarly, the communication interface 285 also enables the local unit 200 to receive global parameters 104 transmitted by the aggregation unit 100. The communication interface 285 provides the global parameters 104 to the local ML-model 208 to update the local ML-model 208. The communication interface 285 may be integrated into the local unit 200, or the communication interface 285 may be embodied as a separate component.

FIG. 5 illustrates a block diagram of communication channel 300. The communication channel 300 is defined by network facilities 302 which enable the transmission of the local parameters 202 from the local units 200 to the aggregation unit 100, as well as the transmission of the global parameters 104 from the aggregation unit 100 to the local units 200. The network facilities 302 may include any combination of networking devices and components. In particular, if the aggregation unit 100 is a cloud-computing system, the network facilities 302 may include network stations and/or transmission lines. The network facilities 302 may be configured to transmit data via any practical standards or protocols.

FIG. 6 illustrates a block diagram of the aggregation unit 100. Generally, the aggregation unit 100 performs several tasks. First, the aggregation unit 100 analyzes the local parameters 202 transmitted by the local units 200 to determine a list 118 of which of the local units 200 are trusted and which are compromised. Second, the aggregation unit 100 aggregates the local parameters 202 to produce a global ML-model 208 defined by global parameters 104. Third, the aggregation unit 100 then transmits the global parameters 104 to the local unit 200 according to the list 118 of trusted and compromised local units 100.

As shown in FIG. 6, a communication interface 185 of the aggregation unit 100 is used to receive the local parameters 202 transmitted via the local units 200 by way of the communication channel 300. The communication interface 185 then relays the received local parameters 202 to a local model's pre-processing component 119. The communication interface 185 may also provide additional data with the local parameters 202 identifying the local unit 200 associated with each parameter 202. The pre-processing component 119 then analyzes the local parameters 202 to determine a list 118 of compromised and trusted local units 100. The list 118 may be determined according to a set of pre-processing rules 111. The pre-processing rules 111 may employ various methods and tools to distinguish between trusted and compromised local units 100. For example, the pre-processing rules 111 may employ statistical methods to analyze the distribution of the received local parameters 202 and divide them into clusters. These clusters may be further used to categorize local units 200 and decide which of them will be discarded from the distribution of the global parameters 104.

In some examples, the pre-processing rules 111 may configure the pre-processing component 119 to determine one or more indicators 102 for each of the local units 100 based on the provided local parameters 202. For example, a truth indicator 106, a reputation indicator 108, and a trust indicator 110 may be determined for each local unit 200. These indicators 106, 108, 110 may be non-binary values between 0 and 1. The truth indicator 106 may be determined by evaluating the data quality of the local parameters 202 associated with the local unit 200. The data quality evaluation may compare the values of the local parameters 202 to known ground truth values or expected values. Accordingly, the truth indicator 106 simply represents the quality of the local parameters 202 most recently provided by a local unit 200. The reputation indicator 108 is determined based on the current truth indicator 106 as well as a plurality of historical truth indicators 112 associated with the local unit 200 under evaluation. Accordingly, the reputation indicator 108 represents the quality of the local parameters 202 produced by the local unit 200 over a period of time. The trust indicator 110 is determined based on the current truth indicator 106 as well as the previous time moment reputation indicator 114. In a time series where present time is defined as t, the previous time moment may be defined as t−1. Further, threshold values may be assigned for each indicator type, such that a local unit 200 may be designated as a compromised unit 204 if one or more indicator values drop below their associated thresholds. More detail regarding the pre-processing rules 111 is provided below.

The pre-processing component 119 conveys the list 118 of compromised local units 204 and trusted local units 206 to a local update knowledge database 113. The local update knowledge database 113 may then convey the list 118 to the other aspects of the aggregation unit 100. The local update knowledge database 113 could also store additional information, such as data regarding the various indicators 102 determined by the pre-processing component 119.

An aggregation component 121 of the aggregation unit 100 receives the local parameters 202 from the pre-processing component 119. The aggregation component 121 may also receive the list 118 of compromised local units 204 and trusted local units 206. The aggregation component 121 aggregates the local parameters 202 into a global ML model 116. The aggregation component 121 may be any appropriate aggregation function, such as federated averaging. The aggregation functions may be defined by aggregation rules 115. Further, having received the list 118 of compromised local units 204 and trusted local units 206, the aggregation component 121 may only aggregate local parameters 202 associated with trusted local units 204, thereby discarding the local parameters 202 associated with compromised local units 206.

The aggregation component 121 provides global parameters 104 associated with the global ML model 116 to the communication interface 185. The communication interface 185 also receives global parameter distribution rules 117 informing the communication interface 185 how to transmit the global parameters 104. In some examples, the global parameter distribution rules 117 may inform the communication interface 185 to only transmit the global parameters 104 to trusted local units 206, thereby excluding compromised units 204 from the global update. The communication interface 185 may then use the list 118 of compromised local units 204 and trusted local units 206 to transmit the global parameters 104 to only the trusted local units 206, thereby excluding the compromised local units 204. In other examples, additional actions against a compromised unit 204 may be implemented, such as completely blocking communication with the aggregation unit 100 or transmitting verification parameters 120 of a specially constructed aggregated verification model to verify the local units 200 were compromised.

FIG. 7 is a detailed functional block diagram of the federated learning system 10. As previously described, the federated learning system 10 includes the aggregation unit 100, the one or more local units 200, and the communication channel 300. The local units 200 transmit the local parameters 202 corresponding to their local ML-models 208 to the aggregation unit 100 via the communication channel 300. The aggregation unit 100 processes the local parameters 202 to determine which of the local units 100 are trusted, and which of the local units 200 may be compromised. The aggregation unit 100 aggregates the provided local updates 202 and updates the global ML-model 116. The aggregation unit 100 then transmits, via the communication channel 300, the global parameters 104 defining the global ML-model 116 to the local units 200 except for the local units 200 which have been determined to be compromised.

FIG. 8 is a schematic diagram of a non-limiting example of an aggregation unit 100. As shown in FIG. 8, the aggregation unit 100 may include the processor 125, the memory 175, and the communication interface 185. The aggregation unit 100 further includes the pre-processing component 119 and the aggregation component 121 which may be executed by the processor 125. The memory 175 is configured to store variety of data including the local parameters 202, the global parameters 104, the pre-processing rules 111, the local update knowledge 113, the aggregation rules 115, the global ML-model 116, the global parameter distribution rules 117, and the list of compromised and trusted local units 118. The memory 175 may also store the indicators 102 associated with the local units, including the truth indicators 106, the reputation indicators 108, the trust indicators 110, the historical truth indicators 112, and the previous time moment reputation indicators 114. The communication interface 185 is configured to receive the local parameters 202 and transmit the global parameters 104.

FIG. 9 is a schematic diagram of a non-limiting example of a local unit 200. As shown in FIG. 9, the local unit 200 may include the processor 225, the memory 275, and the communication interface 285. The local unit 200 may further include the one or more sensors 212 to capture the local data 210. The memory 275 is configured to store a variety of data including the global parameters 104, the local parameters 202, the local ML-model 208, and the local data 210. The communication interface 285 is configured to transmit the local parameters 202 and receive the global parameters 104.

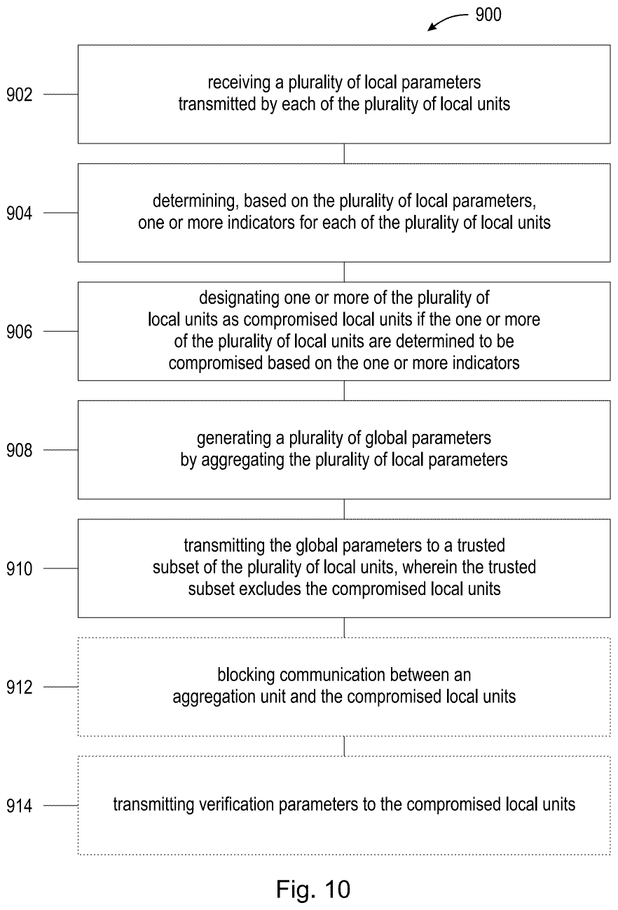

FIG. 10 is a flow chart of a method 900 for excluding one or more of a plurality of local units from a federated learning system. The method 900, in step 902, includes receiving a plurality of local parameters 202 transmitted by each of the plurality of local units 200.

The method 900 further includes, in step 904, determining, based on the plurality of local parameters 202, one or more indicators 102 for each of the plurality of local units 200.

The method 900 further includes, in step 906, designating one or more of the plurality of local units 200 as compromised local units 204 if the one or more of the plurality of local units 200 are determined to be compromised based on the one or more indicators 102.

The method 900 further includes, in step 908, generating a plurality of global parameters 104 by aggregating the plurality of local parameters 202.

The method 900 further includes, in step 910, transmitting the global parameters 104 to a trusted subset 206 of the plurality of local units 200, wherein the trusted subset 206 excludes the compromised local units 204.

According to an example, the method 900 may further include, in optional step 912, blocking communication between an aggregation unit 100 and the compromised local units 204.

According to an example, the method 900 may further include, in optional step 914, transmitting verification parameters 120 to the compromised local units 200.

Below is a description of an example of using data quality as a basis for determining the aforementioned indicators to classify the local units as trusted or compromised.

### Data Quality Evaluation in a Federated Learning Environment

Reputation and Trust indicators allow the federated learning system to effectively trace and evaluate the trustworthiness of agents in distributed systems, and to detect agents that perform actions detrimental to system performance. However, the conventional Reputation and Trust evaluation approaches possess a significant challenge related to the initial indicators' value calculation. This is associated with the uncertainty and lack of knowledge about the agents in the system initialization moment or if a new agent joins the existing system, when no contributions have been made by the agents that can be evaluated. In this case, the initial Reputation and Trust values are usually defined by a constant (e.g., 0.5). An alternative approach is to evaluate and employ the data quality (DQ) of the initial data update, provided by the agent in the system initialization moment. Though, in the case of federated learning, the data is kept private at the data source and is inaccessible from the outside.

The methods, calculus, and instrumentation employed for DQ evaluation may vary depending on the context and application requirements. Technical, security, and operational characteristics of the sensor-embedded data sources can be employed for evaluating the DQ they provide. In the federated learning scenario, the DQ possessed by the local units can be evaluated in a similar way-based on technical, operational, and security characteristics of the devices that store the local data and train ML models based on this data, if they are accessible.

DQ evaluation in federated learning can be employed to detect malicious attacks against local units, as a DQ indicator can serve as a criterion to detect and mitigate such attacks. Malicious attacks against local units in federated learning usually involve the manipulation of the data or the model update parameters to compromise the performance, integrity, or security of the global model. For example, data poisoning attacks involve injecting malicious data into the local dataset to mislead the learning process. Model poisoning attacks involve modifying the local model update parameters to corrupt or sabotage the global model.

DQ evaluation can be employed to detect these attacks by measuring and evaluating the DQ of the local units based on various factors, such as accuracy, power consumption, latency, security, and others, depending on the particular local unit's implementation and data sources used. These factors can be derived from the local unit's technical characteristics or measured empirically. Based on the DQ scores, the aggregation unit can identify and isolate the malicious or faulty local units that possess low-quality or corrupted data due to malicious attacks or failures. This can prevent compromised units from participating in federated learning and affecting the performance and security of the global model.

To measure the DQ possessed by the local units, various factors must be considered that affect the DQ evaluation components, which, depending on the implementation and application requirements, can be derived from the device's technical characteristics. For example, if the local unit employs a sensor data collecting device, its accuracy can be gauged by comparing the sensor readings with a reference value or a ground truth. To evaluate the DQ possessed by the local unit, assign weights and scores need to be assigned to each factor according to their importance and relevance for the application or task. The weights reflect how much each DQ factor contributes to the overall DQ value. The scores reflect how well the local unit performs on each factor. The weights can be normalized to a range between 0 and 1 for the sake of operation convenience and comparability. Then, the overall DQ score for each local unit can be computed according to the following.

First, let I be the set of local units that participate in federated learning. Second, let F be the set of DQ factors that can be evaluated based on the local unit's device characteristics, and are relevant for the application or task. Third, let w_{f} be the weight of factor f∈F, such that Σ_{f∈F}w_{f}=1. Fourth, let q_{i,f} be the DQ score of device i∈I for factor f∈F. Then, the overall DQ score for device i may be calculated according to equation (1):

$${DQ}_{i} = {\sum }_{f ∈ F} {w}_{f} \cdot {q}_{i , f} \qquad ( 1 )$$

The DQ score of local unit i reflects how well it's characteristics (parameters) satisfy the federated learning application requirements. This DQ calculation can be employed for detecting malicious local units by comparing the DQ scores of various local units and identifying the local units that have lower scores than the established threshold or a majority norm. This can indicate that the local units have been compromised by malicious attacks that affect the quality of their data or model updates. Below we elaborate on the DQ evaluation practical use case for the federated learning scenario.

### Data Quality Calculation Use Case in Federated Learning Scenario

Let us assume that four local units (I=i₁, i₂, i₃, i₄) participate in federated learning for training the ML model. Suppose two DQ evaluation factors: F=PRF, FRS, where PRF is the performance demonstrated by the ML model over the input data, and FRS is the freshness of the local update provided by the local unit for aggregation (i.e., the time elapsed from the federated learning training initialization moment or from the previous local update received by the aggregation unit). Suppose we assign equal weights: w_{PRF}=w_{FRS}=0.5 to both factors. Suppose the performance score q_{i,PRF} is measured by comparing the local model accuracy with the global model performance, such that q_{i,PRF}=PRF_{L}/PRF_{G}, where PRF_{L} is the local model's accuracy and PRF_{G} is the global model accuracy. Suppose the freshness score q_{i,FRS} is measured by comparing the age of the local model update with a threshold (e.g., 10 minutes), such that q_{i,FRS}=1−tᵢ/10, where tᵢ is the age of the local model update in minutes. Suppose the performance and freshness values for each local unit are represented in Table 1 below.

TABLE 1

| Local Unit | Performance | Age (minutes) |
|---|---|---|
| i₁ | 90 | 5 |
| i2 | 85 | 8 |
| 13 | 50 | 12 |
| i4 | 95 | 3 |

Suppose the performance of the global model, aggregated based on the local models, is 90%. Then, the DQ scores can be computed for each local unit as follows:

For the local unit i₁:

$${q}_{i 1 , PRF} = {PRF}_{L} / PRFG = 90 / 90 = 1 ;$$

$${q}_{i 1 , FRS} = 1 - {t}_{i} / 10 = 1 - 5 / 10 = 0.5 ; and$$

$${DQ}_{i 1} = 0.5 \cdot 1 + 0.5 \cdot 0.5 = 0.75 .$$

For the local unit i₂:

$${q}_{i 2 , PRF} = {PRF}_{L} / {PRF}_{G} = 85 / 90 = 0.94 ;$$

$${q}_{i 2 , FRS} = 1 - {t}_{i} / 10 = 1 - 8 / 10 = 0.2 ; and$$

$${DQ}_{i 2} = 0.5 \cdot 0.94 + 0.5 \cdot 0.2 = 0.57 .$$

For the local unit i₃:

$${q}_{i 3 , PRF} = {PRF}_{L} / {PRF}_{G} = 50 / 90 = 0.56 ;$$

$${q}_{i 2 , FRS} = 1 - {t}_{i} / 10 = 1 - 12 / 10 = - 0.2 ; and$$

$${DQ}_{i 3} = 0.5 \cdot 0.56 + 0.5 \cdot ( - 0.2 ) = 0.18 .$$

For the local unit i₄:

$${q}_{i 4 , PRF} = {PRF}_{L} / {PRF}_{G} = 95 / 90 = 1.06 ;$$

$${q}_{i 4 , FRS} = 1 - {t}_{i} / 10 = 1 - 3 / 10 = 0.7 ; and$$

$${DQ}_{i 4} = 0.5 \cdot 1.06 + 0.5 \cdot 0.7 = 0.88 .$$

From these scores, it can be seen that is local unit possesses the lowest DQ, which may indicate that it has been compromised by a malicious attack. For example, it may have injected malicious data into its dataset to reduce its accuracy or delayed its model update that increased its age.

Employing the local unit DQ evaluation for Reputation and Trust indicators initialization can help to establish these indicators in the conditions of uncertainty or lack of knowledge (i.e., in the federated learning system initialization moment). For example, one of the local units may be compromised by an adversary who wants to tamper with the data or the model in federated learning. Alternatively, a local unit may fail due to hardware or software errors, network issues, or environmental factors. These scenarios can result in low-quality or malicious data that can affect the performance or security of federated learning. Integrating DQ evaluation with Reputation and Trust results in more informed indicators assessment, and helps to mitigate the uncertainty conditions that might be exploited by an adversary to commit detrimental actions.

### Developed Approach to Trust Evaluation in Federated Learning

To evaluate local unit DQ in the federated learning setting, clustering the ML models trained over a local data and provided by the units for the aggregation is relied on. The local units might generate data whose distribution strongly deviates from the majority as a result of the data source failure (e.g., improper sensor device operation) or malicious attacks against the local unit and as a result train deviating models. This clustering approach allows to distinguish these models from the other majority. Hence, it is assumed that the majority of the models are trained on a high-quality data, and the shift in the local data distribution is an indication of the anomalous data patterns. This assumption allows for defining the quality of local models based on the local data source's DQ.

To preserve the local data privacy, we utilize models trained over the local data and analyze their parameters distribution. Before the aggregation, we cluster the received local models in their parameter space, and calculate the distance from the cluster's center to each model. Below the theoretical foundations for the Reputation and Trust evaluation approach are described.

### Reputation and Trust Fundamentals

Three basic models may be defined: Truth, Reputation (R), and Trust. Truth is an indicator characterizing how the DQ of the local model, provided by the local unit, satisfies the established ML application requirements. This value can be formalized according to equation (2):

$${Truth}_{t} = {f}_{{Tr}_{t}} ( DQ ) , \qquad ( 2 )$$

where Truthₜ is a value representing how the DQ of the model, provided by the local unit for aggregation, satisfies the established requirements in the time moment t, and f_{Tr}_{ₜ} is the function employed to evaluate Truth in the time moment t.

Reputation (R) is an indicator that reflects the data source's historical “behavior” since the system's operational beginning. R is a historically accumulated indicator that is based on the combination of the current and previous Truth values. R value is formalized according to equation (3).

$${R}_{t} = {f}_{{R}_{t}} ( {Truth}_{t} ) = {f}_{{R}_{t}} ( {f}_{{Tr}_{t}} ( D Q ) ) , \qquad ( 3 )$$

where Rₜ is the local unit's Reputation value at t time moment, and f_{R}_{ₜ} is the function employed to calculate R value in t time moment.

Based on the above indicators, the historical knowledge on the DQ provided by local units can be gathered. Moreover, this knowledge allows for tracking the temporal changes in the provided DQ and, based on this changes, analyze and diagnose the system for the potential failures. However, using only the R value to decide if the local unit is trusted or not may limit the flexibility of the system, make it too sensitive to outliers, and may introduce excessive False Positive and False Negative errors. To mitigate these issues, the Trust indicator is introduced in addition to the previous indicators, which allows for regulating the sensitivity to the changes in DQ values and making the Trust evaluation more robust.

Trust is an indicator calculated based on the combination of R value at the preceding time moment t−1 and current Truth value. Trust can be formalized according to equation (4):

$${Trust}_{t} = {f}_{{Trust}_{t}} ( {R}_{t - 1} , {Truth}_{t} ) = {f}_{{Trust}_{t}} ( {f}_{{R}_{t - 1}} ( {f}_{{Tr}_{t - 1}} ( D Q ) ) , {f}_{{Tr}_{t}} ( D Q ) ) , \qquad ( 4 )$$

where Trustₜ is the Trust value calculated at t time moment, and f_{Trust}_{ₜ} is the function employed to calculate Trust at t time moment.

Each of the presented indicators are based on the aforementioned functions, which are derived from the established ML application requirements. Based on previous empirical evaluations, the indicators provide best results if normalized in the range between 0 and 1. For example, the closer the Trust value to 1, the highest Trust towards the data source is established. Based on this, the following assumptions are introduced for the employed indicators' values: Trust∈[0,1]; R∈[0,1]; and Trust∈[0,1].

Based on the previously introduced definitions, local units' evaluation requires calculating the Truth, R and Trust indicators produced each data source. Suppose that e∈E, E is a set of local units, that can communicate with the aggregation unit through the network facilities. For each e local unit, the vectors for the established indicators can be defined in the following way:

$$\overline{{Truth}_{{e}_{ι}}} = ( {{Truth}_{{e}_{{i}_{t}}}}_{…}^{…} ) ,$$

where Truthₑ_{ᵢ} is the Truth value of the local unit eᵢ, calculated based on the local model submitted for aggregation in t time moment;

$$\overline{{R}_{{e}_{ι}}} = ( {{R}_{{e}_{{i}_{t}}}}_{…}^{…} ) ,$$

where Rₑ_{ᵢₜ}, is the Reputation of the local unit eᵢ, calculated based on the local model submitted for aggregation in t time moment; and

$$\overline{{Trust}_{{e}_{ι}}} = ( {{Trust}_{{e}_{{i}_{t}}}}_{…}^{…} ) ,$$

where

$${Trust}_{{e}_{{i}_{t}}}$$

is the Trust towards the local eᵢ calculated based on the local model submitted for aggregation in t time moment.

### Employing Reputation and Trust Indicators for Trust Evaluation in Federated Learning

Instead of using binary data correctness indicators, R is calculated based on the normalized Euclidean distance d from the major cluster center. The initial value of R is calculated according to equation (5):

$${R}_{i}^{{t}_{0}} = 1 - {d}_{i} , R , d ∈ [ 0 , 1 ] ⊂ R , \qquad ( 5 )$$

where

$${R}_{i}^{{t}_{0}}$$

is the Reputation value calculated for the i-th unit in the initial t₀ time moment (after the first local training round); and dᵢ is a normalized Euclidian distance from the cluster's center towards the model provided by i-th unit for aggregation. The value of R is updated in each aggregation round, so if d≥α, where α is a specified threshold (α=0.5 in this case), R grows linearly. Otherwise, if d≤α, R decreases exponentially. The i-th unit's Reputation value for the current time moment t, other than t₀, is calculated according to equations (6) and (7):

$${R}_{i}^{t} = \{ \begin{matrix}( {R}_{i}^{t - 1} + {d}_{i} ) - ( \frac{{R}_{i}^{t - 1}}{t} ) , if d \geq α \\ ( {R}_{i}^{t - 1} + {d}_{i} ) - {e}^{- ( 1 - d ( {R}_{t}^{t - 1} / t )} , if d < α\end{matrix} \qquad ( 6 )$$

$${R}_{i}^{t} = \{ \begin{matrix}1 , & if R \geq 1 , \\ 0 , & if R \leq 1\end{matrix} \qquad ( 7 )$$

where

$${R}_{i}^{t - 1}$$

is i-th local unit's Reputation value calculated in the previous t−1 time moment (in the previous aggregation round). This feature allows for penalizing local units heavily for providing low quality models and requires them to submit positive contributions for a considerable time to build their Reputation. This distance is employed to establish Reputation and Trust indicators that are updated for each local client in each aggregation round.

Based on R, the Trust indicator is calculated, which is a function of R that regulates how the change in R affects the Trust toward the local unit. If the Trust<β, where β is the established threshold (β=0.5 in our case), the parameters of the model provided by the local unit are excluded from this and following aggregation rounds. In terms of the current aggregation round, the Trust indicator is calculated according to equations (8) and (9), where

$${Trust}_{i}^{t}$$

is the rust toward the i-th local unit in the t time moment.

$${Trust}_{i}^{t} = \sqrt{{( {R}_{i}^{t} )}^{2} + {d}_{i}^{2}} - \sqrt{{( 1 - {R}_{i}^{t} )}^{2} + {( 1 - {d}_{i} )}^{2}} , Trust ∈ [ 0 , 1 ] ⊂ R \qquad ( 8 )$$

$${Trust}_{i}^{t} = \{ \begin{matrix}1 , & if Trust \geq 1 , \\ 0 , & if Trust \geq 1\end{matrix} \qquad ( 9 )$$

Below the advantages the above-described DQ and Trust evaluation-driven federated learning offers are compared against the existing approaches.

First, the above-described approach is DQ-focused, as it prioritizes local training DQ, irrespective of how the degradation occurred, whether through malicious intent or unintentional failures. By integrating the local DQ and Trust evaluations, this approach enables detecting local units that possess low quality data and submit harmful updates that degrade the global model performance regardless of the reason. Moreover, this approach opens a great avenue for integrating the knowledge on various data source characteristics that can be employed to evaluate its DQ and security. The use of this knowledge in a combination with other units' Trust evaluation methods contributes to a more informed and accurate Trust measure. For example, the evaluation of DQ might not be limited to only clustering the model updates, and might include considering data source characteristics (e.g., the range, resolution, and accuracy of the sensor device that produce the data). In addition, the data source computational platform security characteristics might be employed for the Trust evaluation process. The integration of knowledge on data source characteristics, the models clustering results, and the calculated Reputation and Trust indicators enable more informed and accurate local units' Trust estimation, which contributes to better detection of those units who possess low quality data and train low quality models based on this data.

Second, the above-described approach uses Trust-based filtering. Instead of selecting local units for aggregation, it is decided which units should be discarded from aggregation based on Trust towards them. The developed calculus quantifies Reputation and Trust indicators, and allows to evaluate them in a specified numerical range. This allows the federated learning system user to establish a specified level of Trust deemed acceptable for their application. This makes our calculus more flexible and personalized according to the particular data, ML model, and context requirements. Untrusted local units are excluded from further communication, preventing them from receiving further global updates, which enhances privacy and security of federated learning.

Third, the above-described approach uses historical tracking allowing for accumulating and tracing the changes in Trust toward local units over time in a federated learning system. The retrospective data on the quality of models of local units provide for aggregation is employed for Trust evaluation, enabling the identification of untrusted units based on their “prior behavior.” This feature might be highly useful and employed, for example, for extensive security analytics and audit.

Fourth, the above-described approach uses unsupervised clustering and does not require any prior knowledge on the training data and its distribution. It solely relies on the model updates sent by the local units to the aggregation unit. These updates are clustered in an unsupervised manner, and the Trust is calculated based on these clustering results. This approach does not need access to ground truth or the local data distribution in advance for Trust estimation, which allows to enhance federated learning privacy. In addition, the employment of unsupervised clustering requires only the model updates as an input, which makes the approach adaptable to manifold data types and federated learning applications.

### Example 1

A typical example of the disclosed systems and methods may be a federated learning system implemented to train a ML-based global model for anomalous financial transactions identification based on Society for Worldwide Interbank Financial Telecommunications (SWIFT) records proposed for the competition organized by the National Institute of Standards and Technology (NIST) and the National Science Foundation NSF in 2022. The training data is structured and includes various features, such as transaction time and date, sender's bank, receiver's bank, and the like. The data on the transactions is distributed over various financial organizations, which cannot communicate to each other. The data on the transactions includes sensitive information about the bank account owners, such as account owner's name, home or business address, amount of funds sent, and other confidential information. The data on SWIFT transactions performed by various financial organizations might be combined and distributed between multiple local units. The aggregation unit is represented as a remote third party's server to which financial organizations send their local model's updates. As a communication channel between the local units and the aggregation unit, network facilities provided by ISP might be used. At the local training stage, the models are trained over the data stored by each local unit. For example, as training data on each financial organization, transactions' details over a specified time period might be used, e.g., transactions made by all the banks over the last months. As a ML-based model, XGBoost might be used. After the local training, the parameters of the local models are sent to the aggregation unit via the communication channel. The ML-based model's parameters may include gradients, weights, and any other parameters required by the aggregation function.

After receiving local updates, the aggregation unit performs pre-processing of the parameters associated with the local models. As a pre-processing method, statistical analysis might be used. For example, the distribution of the local ML-based model parameters might be analyzed, and these values can be clustered with the k-means algorithm. After clustering, the local units are classified into trusted and compromised according to their model updates. This decision is made on the basis of the assumption that the majority of the local units are honest and non-compromised. If the values of local model parameters of a single or several local unit's distributions significantly deviates from the others, we can assume that the local data or model might be maliciously modified by an adversary. The aggregation unit identifies these local units as compromised, and based on the user and application requirements, may discard their local updates from the further aggregation procedures.

In our example, Reputation and Trust-based mechanisms might be implemented to accumulate knowledge on the trustworthiness of the local units and decide which of the local units should be excluded from the global model distribution. Based on the pre-processing results, a Reputation indicator of each of the local units is established and evaluated. A local unit's Reputation reflects how the local updates sent to the Aggregation unit satisfies the user and application requirements. For example, if the local pre-processing shows that the local model parameters' values lie outside of the major cluster, the Reputation indicator of such local unit will be decreased. Trust toward local units is a function of Reputation and is employed to regulate how the changes in Reputation influence the local units' trustworthiness. The user might set a Trust indicator value threshold. Below the Trust indicator threshold the local unit is considered as compromised and will be discarded from the global model distribution.

After the local models' pre-processing stage, local updates are aggregated using the aggregation function. In our example, the local updates might be selected for aggregation based on Reputation and Trust towards local units. For instance, if the Trust indicator value of the local unit is below the specified threshold, the parameters of the local updates sent by this local unit are excluded from the aggregation. For the aggregation, various aggregation functions can be used, for example, federated averaging or a weight function whose parameters are based on the distance from the local models parameters from the cluster's center. After the aggregation, parameters of the global model are distributed back to the trusted local units, selected with the employed Reputation and Trust-based mechanisms. Reputation and Trust indicators are stored and accumulated on the aggregation unit and are not transferred to any local units. After sending and applying the global updates by all the local units not excluded from the global model distribution, the new aggregation round may be initiated.

In summary, in the above example, the disclosed systems and methods allow for enhancing the privacy and security of the federated learning system. If the adversary has gained unauthorized access to the local unit, they can wait until the local unit receives global model updates, and then apply data inference attacks on it. Such attacks can reveal some sensitive information about the training data stored on other local units participating in the aggregation round. In this example, the training data is SWIFT transactions records, so an adversary, for example, might infer if that data regarding the specified person or transaction is stored in the local data. In this example, it is assumed that the adversary is active and performs malicious manipulations over the training data and/or model on the local unit to which they gained unauthorized access, e.g., data or model poisoning. These malicious manipulations will influence the transmitted local model's parameters, which can be detected by the pre-processing mechanisms. Based on the local models pre-processing results, local units are categorized into trusted and compromised. Potentially compromised local units are discarded from receiving the global model updates, decreasing the risk that the adversary will gain unauthorized access to the global model and apply data inference attacks. Based on this, in the described example, the disclosed system allows for enhanced privacy and security of the training data on financial organizations' SWIFT transactions, distributed over multiple local units participating in the federated learning system.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure. Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed is:

1. A method (900) for excluding one or more of a plurality of local units from a federated learning system, comprising:
receiving (902) a plurality of local parameters transmitted by each of the plurality of local units;
determining (904), based on the plurality of local parameters, one or more indicators for each of the plurality of local units;
designating (906) one or more of the plurality of local units as compromised local units if the one or more of the plurality of local units are determined to be compromised based on the one or more indicators;
generating (908) a plurality of global parameters by aggregating the plurality of local parameters; and
transmitting (910) the plurality of global parameters to a trusted subset of the plurality of local units, wherein the trusted subset excludes the compromised local units.

2. The method (900) of claim 1, wherein the aggregating of the plurality of local parameters excludes a portion of the local parameters corresponding to the compromised local units.

3. The method (900) of claim 1, further comprising blocking (912) communication between an aggregation unit and the compromised local units.

4. The method (900) of claim 3, wherein the aggregation unit is a cloud-based system.

5. The method (900) of claim 1, further comprising transmitting verification parameters to the compromised local units.

6. The method (900) of claim 1, wherein the compromised local units are designated by comparing the one or more indicators of each of the plurality of local units to one or more thresholds.

7. The method (900) of claim 1, wherein the one or more indicators includes one or more of a truth indicator, a reputation indicator, and a trust indicator.

8. The method (900) of claim 7, wherein the truth indicator corresponding to one of the plurality of local units is determined based on a data quality evaluation of the plurality of local parameters associated with the one of the plurality of local units.

9. The method (900) of claim 8, wherein the reputation indicator corresponding to the one of the plurality of local units is determined based on the truth indicator corresponding to the one of the plurality of local units and a plurality of historical truth indicators

10. The method (900) of claim 9, wherein the trust indicator corresponding to the one of the one or more of the plurality of local units is determined based on the truth indicator and a previous time moment reputation indicator.

11. The method (900) of claim 1, wherein the plurality of local units include local machine learning models, and wherein the trusted subset of the plurality of local units update the local machine learning models based on the global parameters.

12. The method (900) of claim 11, wherein the plurality of local parameters are generated by the local machine learning models of the each of the plurality of local units by processing local data.

13. The method (900) of claim 12, wherein the plurality of local units capture the local data via one or more input sensors.

14. A non-transitory computer readable storage medium, the computer readable storage medium having computer readable code embodied therein, the computer readable code being configured such that, on execution by a suitable computer or processor is caused to perform a method (900) comprising:
receiving (902) a plurality of local parameters transmitted by each of a plurality of local units;
determining (904), based on the plurality of local parameters, one or more indicators for each of the plurality of local units;
designating (906) one or more of the plurality of local units as compromised local units if the one or more of the plurality of local units are determined to be compromised based on the one or more indicators;
generating (908) a plurality of global parameters by aggregating the plurality of local parameters; and
transmitting (910) the plurality of global parameters to a trusted subset of the plurality of local units, wherein the trusted subset excludes the compromised local units.

15. A federated learning system (10) comprising an aggregation unit (100), wherein the aggregation unit (100) is configured to:
receive a plurality of local parameters (202) transmitted by each of a plurality of local units (200);
determine, based on the plurality of local parameters (202), one or more indicators (102) for each of the plurality of local units (200);
designate one or more of the plurality of local units (200) as compromised local units (204) if the one or more of the plurality of local units (200) are determined to be compromised based on the one or more indicators (102);
generate a plurality of global parameters (104) by aggregating the plurality of local parameters (202); and
transmit the plurality of global parameters (104) to a trusted subset (206) of the plurality of local units (200), wherein the trusted subset (206) excludes the compromised local units (204).

16. The federated learning system (10) of claim 15, wherein the aggregation unit (100) is a cloud-based system.

17. The federated learning system (10) of claim 15, wherein two or more of the plurality of local units (200) are physically distributed.

18. The federated learning system (10) of claim 15, wherein two or more of the plurality of local units (200) are logically distributed within a single device.

19. The federated learning system (10) of claim 15, wherein the plurality of local parameters (202) are generated by local machine learning models (208) of the each of the plurality of local units (200) by processing local data (210).

20. The federated learning system (10) of claim 19, wherein each of the plurality of local units (200) comprises one or more input sensors (212) configured to capture the local data (210).
